(19) United States
(12) Patent Application Publication
(10) Pub. No.: US 2025/0003435 A1
(43) Pub. Date: Jan. 2, 2025

(54) Seat Grommet

(71) Applicant: Illinois Tool Works Inc., Glenview, IL (US)

(72) Inventor: Mark O. Lepper, Oak Park, IL (US)

(21) Appl. No.: 18/753,527

(22) Filed: Jun. 25, 2024

Related U.S. Application Data
(60) Provisional application No. 63/524,264, filed on Jun. 30, 2023.

(51) Int. Cl. F16B 2/20; B60N 2/015

(52) U.S. Cl. CPC F16B 2/20; B60N 2/015

(57) ABSTRACT

Described is a grommet assembly to secure a first component having a wire component to a second component having an opening. The grommet assembly includes a wire retainer and a grommet assembly. The wire retainer defines a wire cavity configured to receive the wire component. The wire retainer includes one or more grommet-retention features extending outwardly from the wire retainer, and one or more wire prongs extending inwardly into the wire cavity and configured to engage and secure the wire component within the wire cavity. The grommet assembly engages the second component via the opening. The grommet assembly includes a seal, and a grommet defining a retainer cavity that is configured to receive at least a portion of the wire retainer.

### CROSS-REFERENCE

The present application claims priority to U.S. Provisional Patent Application No. 63/524,264, filed Jun. 30, 2023, and entitled “Seat Grommet” which is hereby incorporated by reference in its entirety.

### BACKGROUND

Automotive components require fastening techniques that are simple to manufacture and assemble. Further, fastening techniques should above all be reliable and efficient.

To mount a seat to the vehicle, a seat grommet is fitted into a mounting hole in the panel at the rear of the vehicle. The Wire component, attached to the underside of the rear seat, is then aligned with and pressed into the seat grommet. This engagement ensures that the seat wire is securely locked in place by the grommet, providing a stable and secure attachment of the seat to the vehicle.

Despite advancements to date, a need exists for an improved seat grommet that increased fastening strength while providing other benefits, such as a seal.

### SUMMARY

The present disclosure relates generally to a seat grommet to form a connection between two components, such as automotive seats and panels, substantially as illustrated by and described in connection with at least one of the figures, as set forth more completely in the claims. More specifically, the present disclosure relates generally to a seat grommet to form a connection between two components via a wire component.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a perspective assembly view of an example fastening system having a grommet assembly in accordance with aspects of this disclosure for securing a seat.

FIG. 1b illustrates a perspective assembly view of the fastening system in accordance with aspects of this disclosure.

FIG. 1c illustrates a perspective assembled view of the example fastening system.

FIG. 1d illustrates a side elevation assembly view of the example fastening system.

FIG. 1e illustrates a side elevation assembled view of the example fastening system.

FIG. 1f illustrates a top plan assembled view of the example fastening system.

FIG. 1g illustrates a bottom plan assembled view of the example fastening system.

FIG. 1h illustrates a cross-sectional, side elevation view of the fastener system taken along cutline A-A (FIG. 1f).

FIG. 1i illustrates a cross-sectional, side elevation view of the fastener system taken along cutline B-B (FIG. 1g).

FIGS. 2a and 2b illustrate, respectively, topside and underside perspective assembly views of the example grommet assembly.

FIGS. 2c and 2d illustrate, respectively, top and bottom plan views of the example grommet assembly.

FIGS. 2e and 2f illustrate, respectively, first side elevation and cross-sectional views of the example grommet assembly taken along cutline C-C (FIG. 2c).

FIGS. 2g and 2h illustrate, respectively, second side elevation and cross-sectional views of the example grommet assembly taken along cutline D-D (FIG. 2d).

FIGS. 2i and 2j illustrate, respectively, first and second side elevation assembly views of the example grommet assembly.

FIG. 2k illustrates a side elevation cross sectional assembly view of the example grommet assembly.

FIGS. 3a and 3b illustrate, respectively, side elevation views of the example grommet assembly in an initial position and a final position.

FIGS. 3c and 3d illustrate, respectively, side elevation and cross-sectional views of the example grommet assembly in the initial position.

FIGS. 3e and 3f illustrate, respectively, side elevation and cross-sectional views of the example grommet assembly in the final position.

FIGS. 4a through 4h illustrate an example assembly process for assembling the fastening system through the final position.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a seat grommet to form a connection between two components, such as automotive seats and panels. More specifically, the present disclosure relates generally to a seat grommet to form a connection between two components via a wire component.

The disclosed grommet assembly offers a number of advantages. For example, the wire retention features are molded in the open position. There are no undercuts inside the grommet, eliminating the need for complicated tooling or forced part ejection. Undercuts for fastening the wire fastener are located at the top of the grommet body, accessible by normal slide action in the tool. The grommet body has no open holes below the seal, ensuring superior sealing performance. The open design of the wire retention features provides better access for creating curve-matched wire contact tips and simplifies tooling for lower costs. The design ensures robust, repeatable part production with superior sealing, eliminating the need for additional components or processes to plug holes in the grommet body.

In one example, a grommet assembly to secure a first component having a wire component to a second component having an opening comprises: a wire retainer defining a wire cavity configured to receive the wire component, wherein the wire retainer comprises: one or more grommet-retention features extending outwardly from the wire retainer, and one or more wire prongs extending inwardly into the wire cavity and configured to engage and secure the wire component within the wire cavity; and a grommet assembly configured to engage the second component via the opening, wherein the grommet assembly comprises: a seal; and a grommet defining a retainer cavity that is configured to receive at least a portion of the wire retainer.

In another example, a grommet assembly to secure a first component having a wire component to a second component having an opening comprises: a wire retainer defining a wire cavity configured to receive the wire component, wherein the wire retainer comprises a frame portion and a head portion; a plurality of grommet-retention features extending outwardly from the head portion; a plurality of wire prongs extending from the head portion inwardly into the wire cavity and configured to engage and secure the wire component within the wire cavity; and a grommet assembly configured to engage the second component via the opening, wherein the grommet assembly comprises a seal and a grommet defining a retainer cavity that is configured to receive at least a portion of the wire retainer.

In yet another example, a grommet assembly to secure a first component having a wire component to a second component having an opening comprises: a wire retainer defining a wire cavity configured to receive the wire component, wherein the wire retainer comprises a frame portion and a head portion; a plurality of grommet-retention features extending outwardly from the head portion; a plurality of wire prongs extending from the head portion inwardly into the wire cavity and configured to engage and secure the wire component within the wire cavity; and a grommet assembly configured to engage the second component via the opening, wherein the grommet assembly comprises a seal and a grommet defining a retainer cavity that is configured to receive at least a portion of the wire retainer, and wherein the grommet comprises a set of inner shoulders configured to direct the wire prongs inwardly.

In some examples, the wire retainer comprises a frame portion and a head portion.

In some examples, the frame portion defines the wire cavity.

In some examples, the one or more grommet-retention features are coupled to the head portion

In some examples, the one or more wire prongs are coupled to the head portion resiliently.

In some examples, the one or more wire prongs are coupled to the head portion resiliently.

In some examples, the grommet assembly comprises a grommet body portion and a grommet collar portion.

In some examples, a lip portion is positioned at an interface between the grommet body portion and the grommet collar portion.

In some examples, the seal is coupled to the lip portion.

In some examples, the grommet collar portion comprises a set of vertically aligned slots on each of a pair of opposed sides of the grommet collar portion.

In some examples, the set of vertically aligned slots comprises a first slot that is associated with a first position and a second slot that is associated with the second position.

In some examples, the grommet body portion comprises a set of inner shoulders configured to direct the wire prongs inwardly.

In some examples, a leading edge of one or more wire prongs is shaped to correspond to an interior curvature of the wire component.

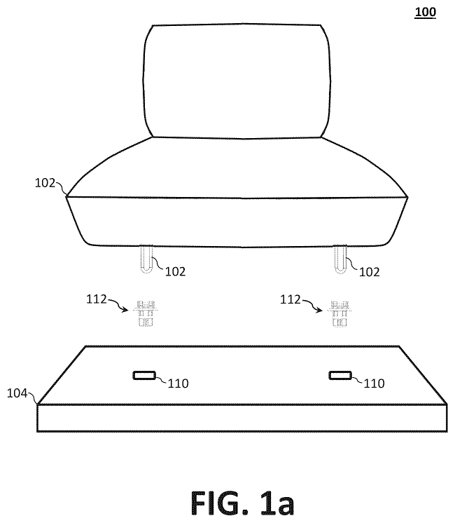

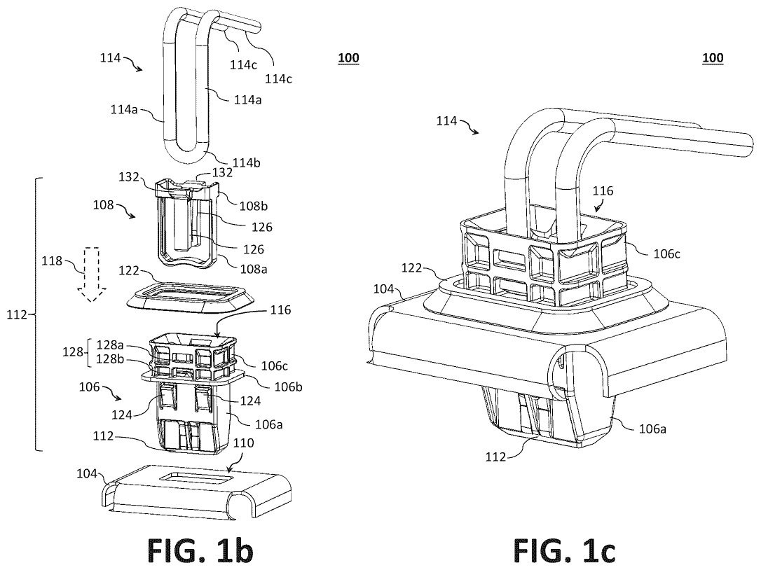

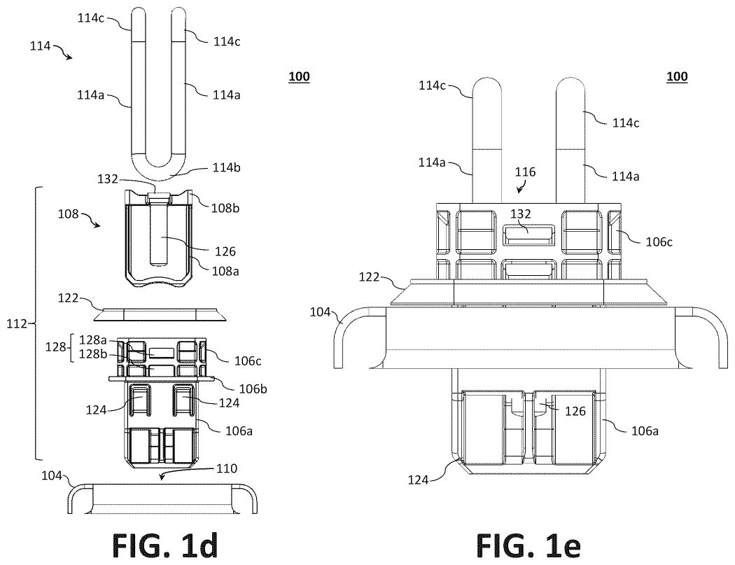

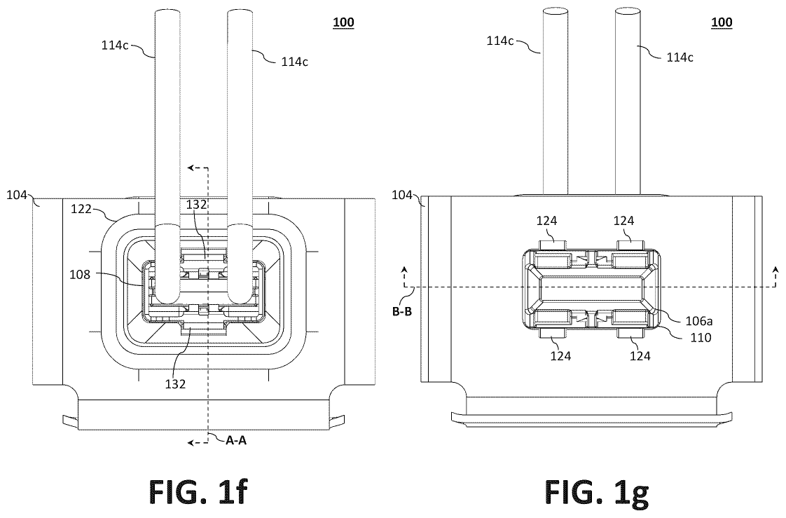

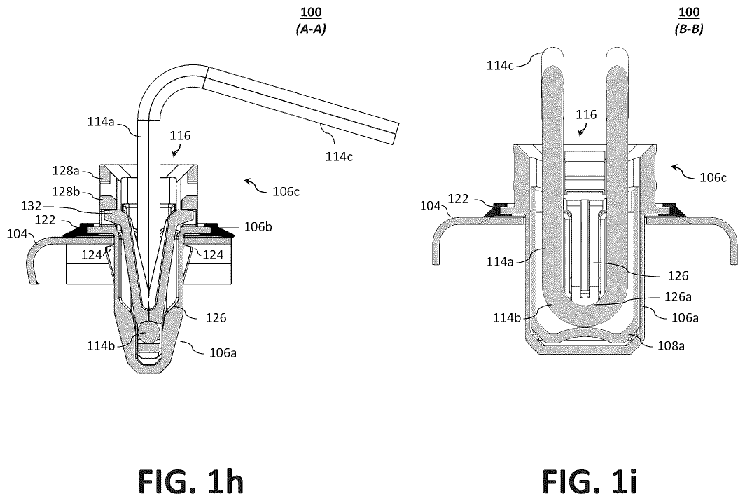

FIG. 1a illustrates a perspective assembly view of an example fastening system 100 having a grommet assembly 112 in accordance with aspects of this disclosure. In this example, the fastening system 100 is configured to form a connection between a first component 102 (illustrated as a seat) having a wire component 114 and a second component 104 (illustrated as a seat frame) having an opening 110. Throughout the disclosure, the wire component 114 is illustrated as a u-shaped wire, however other shapes are possible.

The first component 102 includes, defines, or otherwise provides a wire component 114, which is illustrated as a pair of linear portions 114a that are arrange in parallel and joined by a U-shaped portion 114b, while the second component 104 includes, defines, or otherwise provides an opening 110, which is illustrated as a rectangular window sized to receive the grommet body portion 106a of the grommet 106.

Depending on the application, the first component 102 and the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In one example, the first component 102 is an automotive secondary panel and the second component 104 is an automotive primary panel. In the automotive industry, example first components 102 include, without limitation, seats, door trim panels, moldings, trim pieces, and other substrates (whether use on the interior and exterior surfaces). The second component 104 may be, for example, a structural component of a vehicle, such as seat frames, doors, pillars (e.g., an A-pillar, B-Pillar, C-Pillar, etc.), dashboard components (e.g., a cross member, bracket, frame, etc.), center consoles, fenders, sills, sheet metal framework, or the like.

When the second component 104 is mounted to the first component 102, the grommet assembly 112 can be inserted into an opening 110. The opening 110 can be punched or cut in the first component 102 towards a rear section of a vehicle (e.g., in applications where the second component 104 is a backseat). In the illustrated example, the opening 110 is a generally rectangular window that corresponds to the size and shape of the grommet body portion 106a of the grommet 106.

The grommet assembly 112 is configured to engage a wire component 114, which serves as a hook member and is provided at the underside of the second component 104. When assembled, the second component 104 is covered at least partially by the first component 102. The seal 122 is configured to mitigate water egress through the opening 110.

FIG. 1b illustrates a perspective assembly view of the fastening system 100, while FIG. 1c illustrates a perspective assembled view of the example fastening system 100. FIGS. 1d and 1e illustrate, respectively, side elevation assembly and assembled views of the example fastening system 100. FIG. 1f and 1g illustrate, respectively, top and bottom plan views of the example fastening system 100. FIGS. 1h and 1i illustrate, respectively, cross-sectional, side elevation view of the fastener system taken along cutline A-A (FIG. 1f) and along cutline B-B (FIG. 1g).

As illustrated, the grommet assembly 112 generally comprises a wire retainer 108 and a grommet 106 having a seal 122. During assembly, the wire retainer 108 is inserted into a grommet cavity 116 defined by the grommet 106 to form the grommet assembly 112, which can then be inserted within the opening 110 of the second component 104. In some examples, the wire retainer 108 is inserted into the grommet cavity 116 defined by the grommet 106 to assume an initial position (e.g., a partially secure position). Once the grommet assembly 112 is seated within the opening 110, a leading end of the wire component 114 is inserted into a wire cavity 130 defined by the wire retainer 108. The wire component 114 is then pushed inwardly until the wire retainer 108 is transitioned from the initial position to a final position (e.g., a fully secure position). While illustrated as a separate component, the seal 122 can be integrated with the grommet 106, as will be discussed.

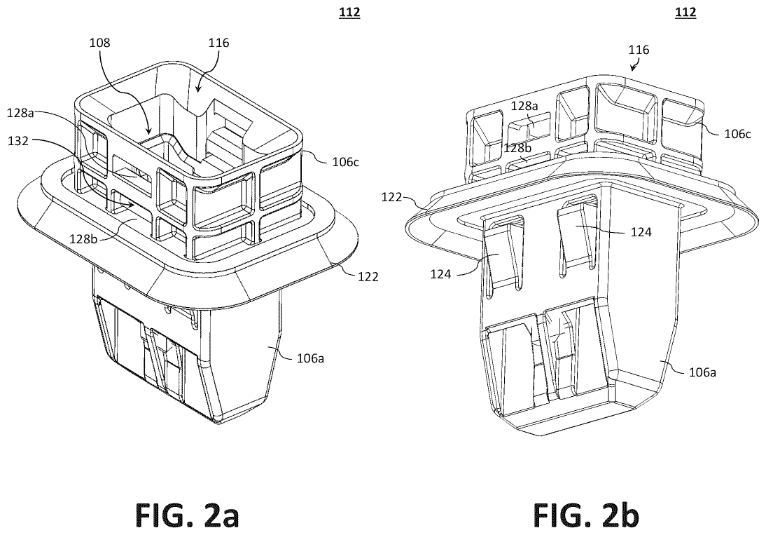

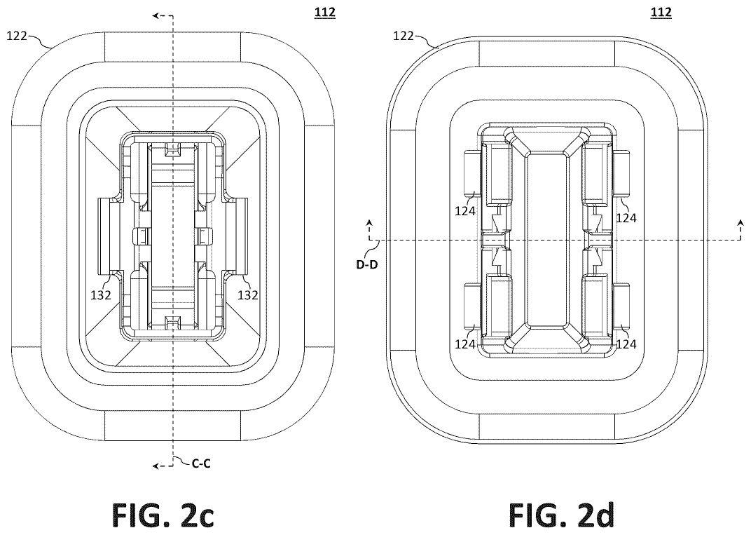

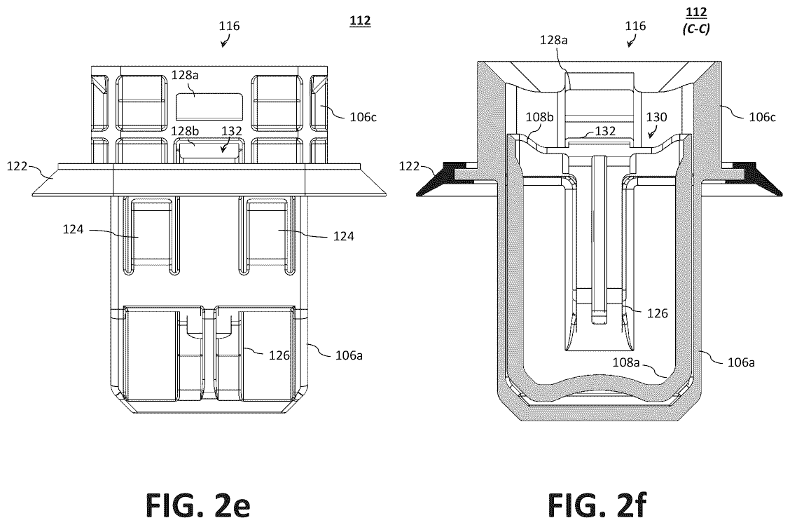

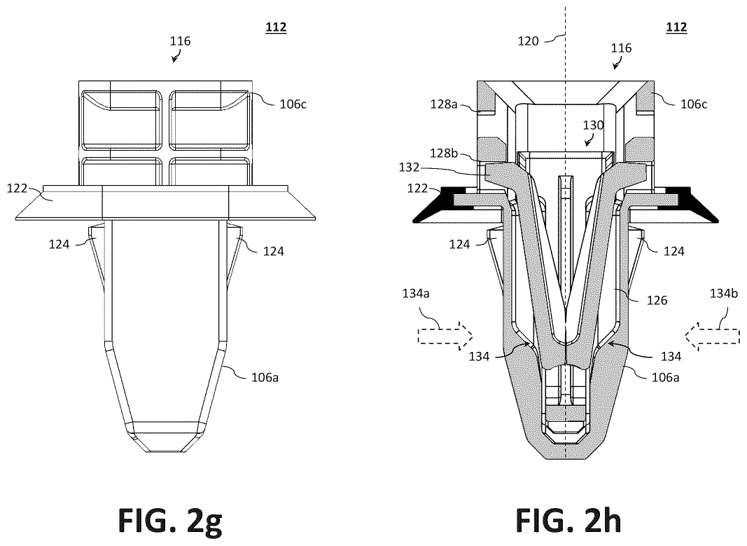

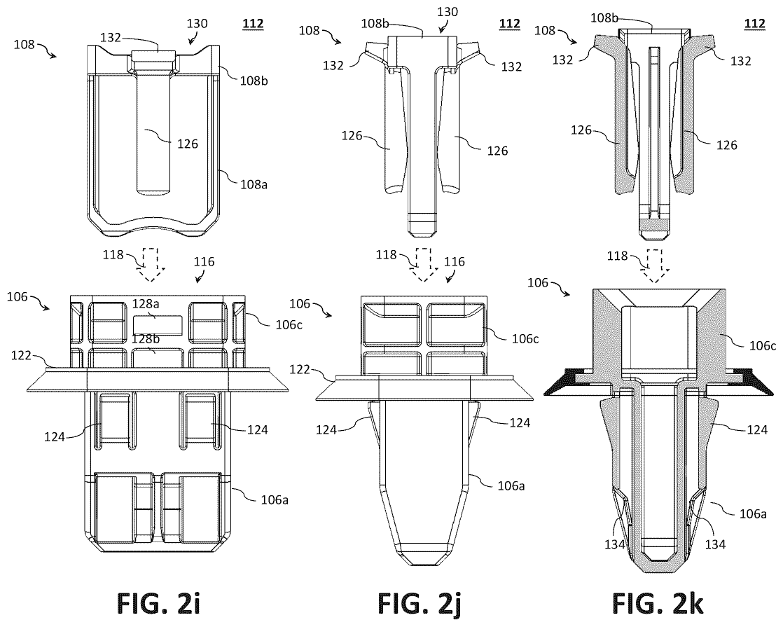

FIGS. 2a through 2k illustrate the example grommet assembly 112 in greater detail and from different views, where the first component 102, the second component 104, and the wire component 114 are omitted to better illustrate the features of the grommet assembly 112. For example, FIGS. 2a and 2b illustrate, respectively, topside and underside perspective assembly views of the example grommet assembly 112, while FIGS. 2c and 2d illustrate, respectively, top and bottom plan views of the example grommet assembly 112. Additionally, FIGS. 2e and 2f illustrate, respectively, first side elevation and cross-sectional views of the example grommet assembly 112 taken along cutline C-C (FIG. 2c), while FIGS. 2g and 2h illustrate, respectively, second side elevation and cross-sectional views of the example grommet assembly 112 taken along cutline D-D (FIG. 2d). FIGS. 2i and 2j illustrate, respectively, first and second side elevation assembly views of the example grommet assembly 112. Finally, FIG. 2k illustrates a side elevation cross sectional assembly view of the example grommet assembly 112.

The illustrated wire retainer 108 includes a frame portion 108a (e.g., a quadrilateral frame, as illustrated) and a head portion 108b (e.g., a cap). The wire retainer 108 defines a wire cavity 130 configured to receive and retain the wire component 114. In the illustrated example, the frame portion 108a is illustrated as generally quadrilateral, though other shapes are contemplated. The frame portion 108a projects or extends perpendicularly from the head portion 108b. In the illustrated example, the head portion 108b is illustrated as generally linear.

The head portion 108b includes one or more grommet-retention features 132 and one or more wire prongs 126 formed therein or thereon. For example, the one or more grommet-retention features 132 can be formed on each side of the head portion 108b and connected to a long side of the head portion 108b. The one or more grommet-retention features 132 can extend outwardly from the head portion 108b at an angle (e.g., perpendicularly, though other angles are contemplated). In the illustrated example, each grommet-retention feature 132 is illustrated as a clip or other protraction configured to snap or clip into a slot 128 formed in or on the grommet body 106, but other shapes and configurations are contemplated.

The frame portion 108a includes or contains one or more wire prongs 126 resiliently coupled to a sidewall of the frame portion 108a and oriented downwardly (e.g., toward the leading end of the frame portion 108a). The one or more wire prongs 126c are configured to engage the wire component 114 (e.g., via an interference fit). For example, each of the wire prongs 126 can be coupled to the sidewall of the frame portion 108a at or adjacent to a grommet-retention feature 132.

The wire retainer 108 may be fabricated in various sizes depending on the application. For example, the size of the wire retainer 108 can be dictated by the size of the first and/or second components 102, 104, the size of the wire component 114, etc. In the fully assembled position, the one or more wire prongs 126 are configured to push and/or retain the wire component 114 within the wire cavity 130. As best illustrated in FIG. 2i, the leading edge 126a (e.g., the edge of the free end) of the one or more wire prongs 126 is shaped (e.g., curved) to correspond to an interior curvature of the wire component 114 (i.e., the interior curve of the U-shaped portion 114b).

The grommet 106 includes a grommet body portion 106a, a grommet collar portion 106c, and a lip portion 106b positioned at the interface between the grommet body portion 106a and the grommet collar portion 106c. The grommet 106 defines a grommet cavity 116 that is sized and shaped to receive the frame portion 108a of the wire retainer 108 and to engage the frame portion 108a via one or more engagement features. In the illustrated example, the grommet body portion 106a comprises one or more slots 128 (e.g., rectangular slots or openings), each of the one or more slots 128 is configured to receive and retain a grommet-retention feature 132 associated with the wire retainer 108.

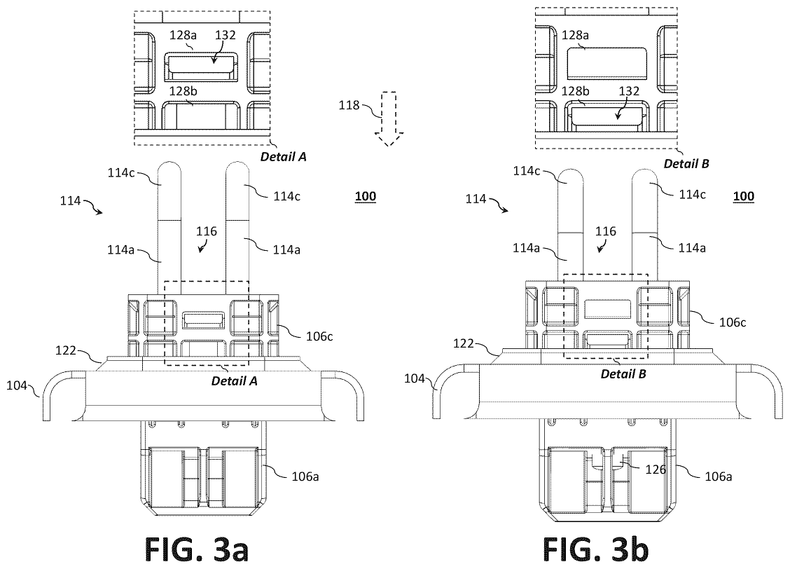

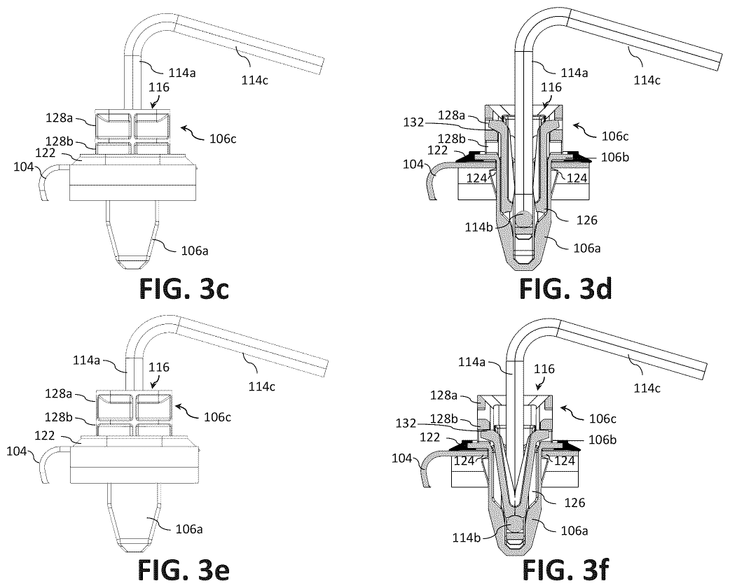

As noted, during assembly, the grommet assembly 112 is configured to transition from the initial position to the final position. FIGS. 3a and 3b illustrate, respectively, side elevation views of the example grommet assembly 112 in the initial position and the final position. FIGS. 3c and 3d illustrate, respectively, side elevation and cross-sectional views of the example grommet assembly 112 in the initial position, while FIGS. 3e and 3f illustrate, respectively, side elevation and cross-sectional views of the example grommet assembly 112 in the final position. In an example, as best illustrated in FIGS. 3a and 3b, the two opposing sides of the grommet collar portion 106c each define a set of vertically aligned slots 128, illustrated as a first slot 128a (e.g., an upper slot) and a second slot 128b (e.g., a lower slot).

In this example, the first slot 128a is associated with the first position, and the second slot 128b is associated with the second position. During assembly, the grommet-retention feature 132 snaps into the first slot 128a to retain the wire retainer 108 relative to the grommet 106 in the first position. When an adequate force is applied toward the leading end (as indicated by arrow 118), the grommet-retention feature 132 moves from the first slot 128a to the second slot 128b, retaining the wire retainer 108 relative to the grommet 106 in the second position.

When fully assembled in the second position, the wire prongs 126 are pushed toward one another, i.e., toward the central axis 120 of the grommet assembly 112, and into a loop formed by the wire component 114. The leading edge of the wire prongs 126 pushes or biases the wire component 114 into the grommet cavity 116 via the interior curvature of the wire component 114.

In some examples, the grommet body portion 106a defines one or more features within the cavity 116 configured to push and/or guide the wire prongs 126 toward the central axis 120 when in the second position. For instance, the illustrated grommet assembly 112 comprises a set of inner shoulders 134 configured to direct (e.g., urge or bias) the wire prongs 126 inwardly (i.e., toward one another as indicated by arrow 134a, 134b), thereby increasing the retention forces of the wire component 114. By pushing the wire prongs 126 toward one another, they are positioned within the opening defined by the wire component and can thus direct force directly against the wire component 114.

The grommet body portion 106a is illustrated as generally rectangular (e.g., a rectangular prism) with a tapered leading end, though other shapes are contemplated, including, for example, cylindrical shapes. The grommet 106 may be fabricated in various sizes depending on the application. In some examples, the wire component 114 further comprises one or more attachment lead portions 114c that are configured to coupled to, dig into, or otherwise engage the first component 102. The one or more attachment lead portions 114c can be positioned at the end of the linear potions 114a opposite the u-shaped portions 114b. As illustrated, the one or more attachment lead portions 114c are transverse relative to the linear portions 114a. For example, the one or more attachment lead portions 114 can be 60-120 degrees relative to an axis of its respective linear portion 114a.

The grommet body portion 106a includes one or more retention tabs 124 resiliently coupled to and extending outwardly from a sidewall of the grommet body portion 106a. The one or more retention tabs 124 are configured to engage the second component 104 via the opening 110 (e.g., via the perimeter). In the illustrated example, the grommet body portion 106a comprises four retention tabs 124 arranged with two retention tabs 124 positioned on opposite sides of the grommet cavity 116. While four retention tabs 124 are illustrated, additional or fewer retention tabs 124 may be employed depending on the size of the grommet 106.

A retention tab 124 may be arranged on each side of the grommet body portion 106a, where desired. In the illustrated example, a pair of one or more retention tabs 124 are configured to retain (e.g., sandwiching the second component 104 between the one or more retention tabs 124 and underside of the lip portion 106b or seal 122). In some examples, the grommet assembly 112 can be inserted into the opening 110 to define the part-in-assembly (PIA).

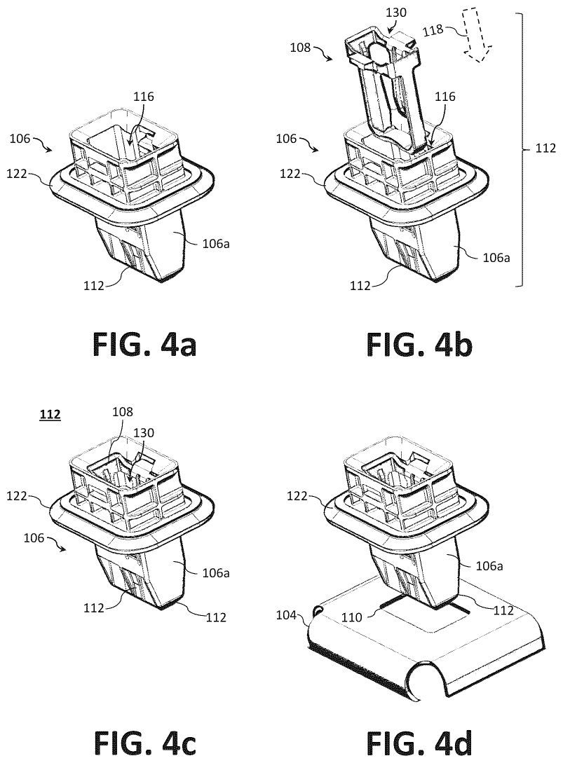

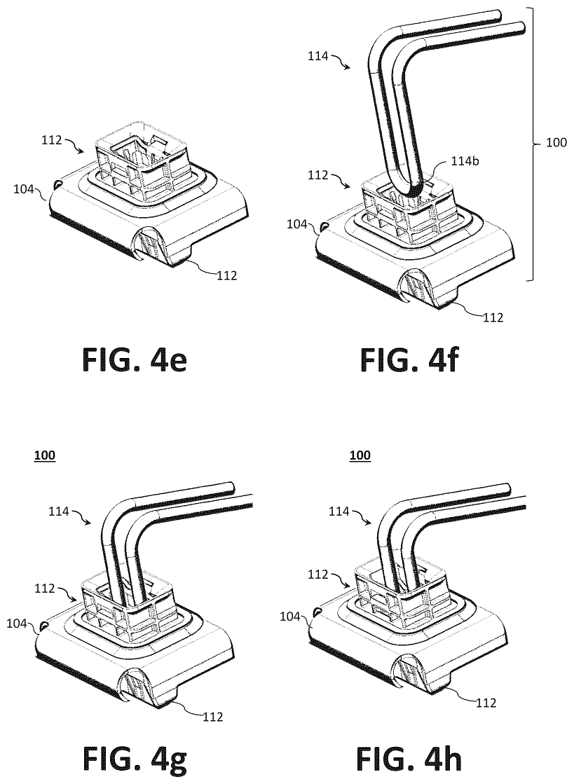

During assembly, it can be useful to assemble the first component 102 and the second component 104 by first inserting the grommet assembly 112 into the opening 110 of the second component 104 to form a part in assembly (PIA), and then inserting the wire component 114 of the first component 102 to form the assembly. An example assembly process for assembling the fastening system 100 through the final position will be described in connection with FIGS. 4a through 4h.

The grommet 106 and the wire retainer 108 can be fabricated from a synthetic or semi-synthetic polymers (e.g., plastics, such as acrylonitrile butadiene styrene (ABS) and polyvinyl chloride (PVC), etc.), composite materials (e.g., fiber glass), or a combination thereof using a plastic injection technique, additive manufacturing, or otherwise. In some examples, the grommet 106 and/or the wire retainer 108 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. In other examples, the grommet 106 and the wire retainer 108 can be fabricated from a metal (or a metal alloy).

The seal 122 may be fabricated from a foam material, thermoplastic, rubber materials, etc. Example thermoplastics include, inter alia, polyethene (PE), polyvinyl chloride (PVC), etc. In another example, the seal 122 can be formed from a die cutting process and positioned on the lip portion 106b. By way of illustration, the seal 122 can be formed separately and overlaid, adhered, or otherwise positioned on the lip portion 106b. For example, the seal 122 can be over-molded and/or formed through at two-shot (2k) process with the grommet 106.

The wire component 114 can be formed by shaping a metallic wire to assume a desired shape. For example, the wire component 114 can be formed by bending a linear section of metal wire to form a desired shape for the wire component 114.

FIGS. 4a through 4h illustrate an example assembly process for assembling the fastening system 100 to assume its final position. In step 1, as shown in FIG. 4a, the grommet 106 (and, where applicable, the seal 122) is provided. In step 2, represented in FIG. 4b, the frame portion 108a of the wire retainer 108 is inserted into the grommet cavity 116 formed within the grommet 106 through a linear motion, such as a straight push in the direction indicated by arrow 118. This insertion can be done directly or via the wire component 114. The wire retainer 108 is pushed inward until it reaches the first position relative to the grommet 106. At this point, the frame portion 108a can be inserted either directly or through the wire component 114. Once in the first position, the grommet 106 and the wire retainer 108 form the grommet assembly 112, as illustrated in FIG. 4c (step 3). The grommet assembly 112 is then inserted into the opening 110, as shown in FIG. 4d (step 4), until the seal 122 is compressed against the second component 104, as depicted in FIG. 4e (step 5).

During this process, a tapered surface at the leading end of the grommet 106 engages the opening 110, compressing the box prongs 126 inward toward the central axis 120. As the box prongs 126 pass through the opening 110, they extend outward away from the central axis 120 (returning to their default position), securing the grommet assembly 112 to the second component 104.

Once the grommet assembly 112 is coupled to the second component 104, the leading end of the wire component 114 is inserted into the wire cavity 130, as illustrated in FIG. 4f (step 6). The wire component 114 is pushed into the wire cavity 130 using a linear motion, indicated by arrow 118, as shown in FIG. 4g (step 7). Finally, the wire component 114 is further pushed into the wire cavity 130 using the same linear motion, as illustrated in FIG. 4h (step 8), until it reaches the second position.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A grommet assembly to secure a first component having a wire component to a second component having an opening, the grommet assembly comprising:
a wire retainer defining a wire cavity configured to receive the wire component, wherein the wire retainer comprises:
one or more grommet-retention features extending outwardly from the wire retainer, and
one or more wire prongs extending inwardly into the wire cavity and configured to engage and secure the wire component within the wire cavity; and
a grommet assembly configured to engage the second component via the opening, wherein the grommet assembly comprises:
a seal, and
a grommet defining a retainer cavity that is configured to receive at least a portion of the wire retainer.

2. The grommet assembly of claim 1, wherein the wire retainer comprises a frame portion and a head portion.

3. The grommet assembly of claim 2, wherein the frame portion defines the wire cavity.

4. The grommet assembly of claim 2, wherein the one or more grommet-retention features are coupled to the head portion.

5. The grommet assembly of claim 2, wherein the one or more wire prongs are coupled to the head portion resiliently.

6. The grommet assembly of claim 5, wherein the one or more wire prongs are coupled to the head portion resiliently.

7. The grommet assembly of claim 1, wherein the grommet assembly comprises a grommet body portion and a grommet collar portion.

8. The grommet assembly of claim 7, wherein a lip portion is positioned at an interface between the grommet body portion and the grommet collar portion.

9. The grommet assembly of claim 8, wherein the seal is coupled to the lip portion.

10. The grommet assembly of claim 7, wherein the grommet collar portion comprises a set of vertically aligned slots on each of a pair of opposed sides of the grommet collar portion.

11. The grommet assembly of claim 10, wherein the set of vertically aligned slots comprises a first slot that is associated with a first position and a second slot that is associated with the second position.

12. The grommet assembly of claim 7, wherein the grommet body portion comprises a set of inner shoulders configured to direct the wire prongs inwardly.

13. The grommet assembly of claim 1, wherein a leading edge of one or more wire prongs is shaped to correspond to an interior curvature of the wire component.

14. A grommet assembly to secure a first component having a wire component to a second component having an opening, the grommet assembly comprising:
a wire retainer defining a wire cavity configured to receive the wire component, wherein the wire retainer comprises a frame portion and a head portion;
a plurality of grommet-retention features extending outwardly from the head portion;
a plurality of wire prongs extending from the head portion inwardly into the wire cavity and configured to engage and secure the wire component within the wire cavity; and
a grommet assembly configured to engage the second component via the opening, wherein the grommet assembly comprises a seal and a grommet defining a retainer cavity that is configured to receive at least a portion of the wire retainer.

15. The grommet assembly of claim 14, wherein the one or more wire prongs are coupled to the head portion resiliently.

16. The grommet assembly of claim 15, wherein the grommet assembly comprises a grommet body portion and a grommet collar portion.

17. The grommet assembly of claim 16, wherein a lip portion is positioned at an interface between the grommet body portion and the grommet collar portion.

18. The grommet assembly of claim 16, wherein the grommet body portion comprises a set of inner shoulders configured to direct the wire prongs inwardly.

19. A grommet assembly to secure a first component having a wire component to a second component having an opening, the grommet assembly comprising:
a wire retainer defining a wire cavity configured to receive the wire component, wherein the wire retainer comprises a frame portion and a head portion;
a plurality of grommet-retention features extending outwardly from the head portion;
a plurality of wire prongs extending from the head portion inwardly into the wire cavity and configured to engage and secure the wire component within the wire cavity; and
a grommet assembly configured to engage the second component via the opening,
wherein the grommet assembly comprises a seal and a grommet defining a retainer cavity that is configured to receive at least a portion of the wire retainer, and
wherein the grommet comprises a set of inner shoulders configured to direct the wire prongs inwardly.

20. The grommet assembly of claim 19, wherein the one or more wire prongs are coupled to the head portion resiliently.
